(19) United States
(12) Patent Application Publication
(10) Pub. No.: US 2026/0017503 A1
(43) Pub. Date: Jan. 15, 2026

(54) SYSTEMS AND METHODS FOR BIT-AUGMENTED ARITHMETIC CONVOLUTION

(71) Applicant: Tesla, Inc., Austin, TX (US)

(72) Inventors: Ritvik RAWAT, Sunnyvale, CA (US); Hasan UNLU, Mountain View, CA (US); Valeriy ROTAN, Los Gatos, CA (US); Srihari SADHU SAMPATHKUMAR, Palo Alto, CA (US)

(73) Assignee: Tesla, Inc., Austin, TX (US)

(21) Appl. No.: 19/258,535

(22) Filed: Jul. 2, 2025

Related U.S. Application Data
(60) Provisional application No. 63/669,049, filed on Jul. 9, 2024.

(51) Int. Cl. G06N 3/06; G06N 3/0464; G06T 19/00

(52) U.S. Cl. CPC G06N 3/06; G06N 3/0464; G06T 19/003

(57) ABSTRACT

Embodiments include systems and methods for bit-augmented computation. A method can be performed by a circuit for a first bit-width. The method includes obtaining an input data structure including multiple elements of a second bit-width, greater than the first bit-width. The method includes generating a first and a second data structure from the input data structure, the first data structure and the second data structure having a bit-width which does not exceed the first bit-width. The method includes executing, by the circuit, one or more layers of a neural network of a machine-learning architecture to generate a first output, the one or more layers of the neural network taking as inputs the first data structure and a set of one or more weights.

### CROSS-REFERENCE TO RELATED APPLICATION

This application claims priority to U.S. Provisional Application No. 63/669,049, filed Jul. 9, 2024, which is incorporated by reference in its entirety and for all purposes.

### TECHNICAL FIELD

This disclosure relates generally to augmenting an effective number of bits for a hardware pipeline. For example, the bit augmentation can be realized for multiplier-accumulators in a machine learning implementation.

### BACKGROUND

Convolutional neural networks (CNNs) were one of the earliest and most significant type of machine learning network, especially in the domain of computer vision. In recent years, machine learning has undergone a meteoric rise, revolutionized industries, and reshape the technological landscape. Breakthroughs in architecture methodologies, including deep learning, have led to unprecedented levels of performance in tasks such as image recognition/computer vision, natural language processing, and autonomous driving. However, the increased precision of such approaches can prove expensive in terms of power budgets, die area, and other design considerations.

Moreover, a product lifecycle for some goods including graphics processing units (GPU), automobiles, robotics, and so forth, can span decades-several generations of algorithmic development. Even where such products include substantial computational headroom to support updated algorithms, the types of hardware accelerators used may evolve over time, leading to mismatches between a type of hardware in a deployed product and the components that may be associated with an updated model. Improvements in the art are desired.

### SUMMARY

A machine learning architecture configured to execute one or more layers of a machine learning model can include one or more fixed-width hardware elements, such as a multiplier-accumulator (MAC). For example, the MAC can be disposed in a MAC array configured to convolve image data or other datasets. However, some operations can be performed using bit-widths wider than the fixed bit-width of the MAC (sometimes referred to as bit-augmented data). For example, a data bus operatively coupled with the MAC can provide data at lower degrees of precision achievable by other circuit components. Such an approach can be applied to achieve increased precision from lower precision hardware components, or can be used in new designs.

Inclusion of lower bit-width data or components, such as interconnects, busses, processor cores, memory device, registers, or other forms logic units and devices, in new designs can reduce power consumption according to a reduced number of signal state transitions or reduced size and power of bus drivers. The lower bit-width can also reduce circuit area used for routing (or increase line-to-line spacing to improve signal integrity) and may reduce an interconnect density in multi-chip modules, or between functional blocks of a monolithic device. This reduction in power usage or circuit area can exceed the power usage or circuit area used by a MAC. Moreover, even where the inclusion of the MAC leads to a net increase in area or power, the MAC can be placed away from density-critical areas or thermal hot spots, leading to overall improvement to device thermals, die area, or so forth. Further still, application of the techniques of the present disclosure can aid in the re-use of an existing computing device for higher precision data than originally intended. For example, many implementations of convolutional neural networks (CNNs) have been supplemented with higher resolution CNNs, transformer models, attention mechanisms, or other implementations that can use varying hardware resources or bit precision (e.g., lesser or greater precision, such as by replacing an 8-bit dataflow with a 16-bit data flow). Accordingly, compute devices tasked with implementing newer techniques may not only suffer from a lack of some hardware components, the compute devices can also include components that are underutilized according to updated models.

An updated model can operate with bit-augmented data (e.g., image data or other datasets including data elements of higher precision than the fixed-width hardware elements). According to the present disclosure, the MAC array or other fixed-width hardware elements can convolve a predefined kernel with the bit-augmented data to separate the bit-augmented input into multiple planes, such that each of the multiple planes includes data elements of equal or lesser bit-width than the fixed-width hardware elements. Such separation can be referred to as “deplaning,” wherein the separate “planes” refer to logical portions of the input data structure. For example, a first logical plane can include a most significant byte of an input data structure and a second logical plane can include a least significant byte of the input data structure. For example, the data elements of the multiple planes can each have a bit-width of n and the data elements of the bit-augmented data have a bit-width of 2n or 4n. Each of the planes may be processed via the fixed-width hardware elements (e.g., by convolving weights of a layer of a machine learning model across the data). In some embodiments, multiple 2n bit-width products of data elements of the bit-width of n and weights (also having a bit-width of n) can be combined to approximate a convolution of the bit-augmented data with bit-augmented weights. For example, multiple 2n products can be stored in a 2n bit register according to a format to reduce discretization error.

Embodiments may include a method for performing arithmetic on processing hardware. The method may include obtaining, by a circuit hardware-limited to a first bit-width, an input data structure comprising a plurality of elements of a second bit-width, greater than the first bit-width; generating, by the circuit, a first data structure and a second data structure from the input data structure, the first data structure and the second data structure having a bit-width that does not exceed the first bit-width; executing, by the circuit, one or more layers of a neural network of a machine-learning architecture to generate a first output, the one or more layers of the neural network taking as inputs the first data structure and a first set of one or more weights; executing, by the circuit, the one or more layers of the neural network of the machine-learning architecture to generate a second output, the one or more layers of the convolutional neural network taking as inputs the second data structure and a second set of one or more weights; and generating, by the circuit using the first output and the second output, a third output having the second bit-width.

Generating the first data structure and the second data structure may include convolving, by the circuit using an array of multiplier-accumulators (MACs) of the first bit-width, a plurality of predefined kernels with the input data structure. The plurality of predefined kernels may include single-entry matrices. The circuit may convolve the plurality of predefined kernels having a stride length equal to a number of columns of the plurality of kernels.

The neural network may include a convolutional neural network. The first set of one or more weights and the second set of one or more weights may be: of a bit-width not exceeding the first bit-width; and obtained, by the circuit as a single weight element of the second bit-width.

The method may include generating, by the circuit, the first output according to a format having an exponent and a mantissa. The exponent has a greater number of bits than the mantissa. The method may include generating, by the circuit, the first output, the second output, and the third output according to a format. The format has the second bit-width, a mantissa, and an exponent. The exponent has a greater number of bits than the mantissa. The input data structure may include natural numbers. The input data structure may include pixel data of an input image. The input data structure may include image data for a machine vision system configured to navigate a three-dimensional environment based the image data.

The method may further include generating control signals to execute a navigational action to cause an ego vehicle to navigate the environment based on the third output.

The circuit may include multiplier-accumulators configured to: obtain an input word having the first bit-width; obtain weights, of the first set of one or more weights, having the first bit-width; and generate a multiplicand having the second bit-width.

Embodiments may include a system for arithmetic computation. The system includes a circuit hardware-limited to a first bit-width and configured to: obtain an input data structure including a plurality of elements of a second bit-width, greater than the first bit-width; generate a first data structure and a second data structure from the input data structure, the first data structure and the second data structure having a bit-width that does not exceed the first bit-width; execute one or more layers of a neural network of a machine-learning architecture to generate a first output, the one or more layers of the neural network taking as inputs the first data structure and a first set of one or more weights; execute the one or more layers of the neural network of the machine-learning architecture to generate a second output, the one or more layers of the convolutional neural network taking as inputs the second data structure and a second set of one or more weights; and generate, using the first output and the second output, a third output having the second bit-width.

The circuit may be configured to, to generate the first data structure and the second data structure: convolve, using an array of multiplier-accumulators (MACs) of the first bit-width, a plurality of predefined kernels with the input data structure. The plurality of predefined kernels may include single-entry matrices. The circuit may convolve the plurality of predefined kernels having a stride length equal to a number of columns of the plurality of kernels.

The neural network may include a convolutional neural network. The first set of one or more weights and the second set of one or more weights may be: of a bit-width not exceeding the first bit-width; and obtained as a single weight element of the second bit-width.

The circuit may be configured to generate the first output according to a format having an exponent and a mantissa, the exponent having a greater number of bits than the mantissa. The circuit may be configured to generate the first output, the second output, and the third output according to a format. The format may include: the second bit-width; a mantissa; and an exponent. The exponent may have a greater number of bits than the mantissa. The input data structure may include natural numbers.

The circuit may include multiplier-accumulators configured to: obtain an input word having the first bit-width; obtain weights, of the first set of one or more weights, having the first bit-width; and generate a multiplicand having the second bit-width.

Embodiments may include an autonomous vehicle including: one or more sensors and a circuit. The one or more sensors may be configured to generate an input data structure having a plurality of data elements which exceed a first bit-width and are equal to a second bit-width, and consisting of natural numbers. The circuit hardware-limited to data of the first bit-width, and the circuit configured to: obtain the input data structure including the plurality of data elements of the second bit-width; generate, via a convolution using an array of multiplier-accumulators (MACs) of the first bit-width, a plurality of predefined kernels with the input data structure, a first data structure and a second data structure from the input data structure, each of the first data structure and the second data structure having a bit-width that does not exceed the first bit-width; execute one or more layers of a neural network of a machine-learning architecture to generate a first output of the second bit-width, the one or more layers of the neural network taking as inputs the first data structure having the first bit-width and a first set of one or more weights having the first bit-width; and execute the one or more layers of the convolutional neural network of the machine-learning architecture to generate a second output of the second bit-width, the one or more layers of the convolutional neural network taking as inputs the second data structure having the first bit-width and a second set of one or more weights having the first bit-width.

It is to be understood that both the foregoing general description and the following detailed description are exemplary and explanatory and are intended to provide further explanation of the invention as claimed.

### BRIEF DESCRIPTION OF THE DRAWINGS

Non-limiting embodiments of the present disclosure are described by way of example concerning the accompanying figures, which are schematic and are not intended to be drawn to scale. Unless indicated as representing the background art, the figures represent aspects of the disclosure.

FIG. 1A illustrates an example of a data processing system having a machine learning architecture, according to some embodiments.

FIG. 1B illustrates an example block diagram of a data processing system, according to some embodiments.

FIG. 1C illustrates an example vehicle of a data processing system, according to some embodiments.

FIG. 1D illustrates an example of a computing device for a component of a machine learning architecture, according to some embodiments.

FIG. 2A illustrates an example flow diagram for a method of bit-augmented convolution, according to some embodiments.

FIG. 2B illustrates data flow amongst components of a compute device corresponding to a convolutional data flow, according to some embodiments.

FIG. 2C illustrates examples of data formats of binary-data words, according to some embodiments.

FIG. 3 illustrates an example method for performing arithmetic on processing hardware, according to some embodiments.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting to the subject matter presented.

Embodiments described herein include systems and methods related to bit augmented arithmetic convolution. A CNN can be executed according to many parallel multiplier-accumulators (MACs). However, when implemented in hardware, such as in the case of an application specific integrated circuit (ASIC), a MAC can include a predefined bit width, corresponding to a data path of a design architecture. Accordingly, it may be challenging to process higher resolution data than an ASIC was originally designed for. However, according to the present disclosure, convolutional processes (e.g., as implanted by MAC blocks) can be used to generate updated data flows for higher resolution or other updated models. In some embodiments, the systems and methods disclosed herein can be implemented at a compiler or a low-level of a stack such that the particular hardware implementation may be realized transparently to a model or other application-level software. For example, the systems realized according to the present disclosure can operate at a same precision, data throughout, or performance as native hardware mated with bit-augmented models (e.g., models involving larger bit widths than are available in a MAC or other hardware component), in some embodiments.

More particularly, an input may be received by multiple MACs or other hardware components. The input can have a greater bit-width than a hardware component, such as a sixteen-bit input provided relative to one or more eight-bit MACs. A deplaning operation can deplane a first portion of the input from a second portion of the input. Continuing the example of the sixteen-bit input provided for an eight-bit MAC, the two portions of the input can be provided separately to two eight-bit MACs. In other instances, the deplaning operation can include additional portions (e.g., for a sixty-four-bit input, provided relative to a sixteen-bit MAC).

Even where the deplaning operation includes separation of a most significant byte (MSB) from a least significant byte (LSB), (e.g., continuing the previous example), an arithmetic logic unit (ALU) including a shift register or other component to so separate the input may not be disposed proximal to other hardware. For example, such an operation could saturate memory bandwidth transporting highly parallelized data to a limited number of ALUs, imposing latency so as to degrade a user experience. In some instances, such as for a perception units of an autonomous driving system, the incurred latency can degrade or even render a system inoperable. Accordingly, convolutional hardware (e.g., MACs) can be used for the deplane operation (e.g., to obviate the memory transfer). Continuing the sixteen-bit example from above, a first plane (including the MSB of a data array) can be generated according to a 1×2 convolutional kernel having a stride length of 2. That is, a byte kernel of [1 0] can multiply every upper byte (MSB) by one and every lower byte (LSB) by zero. The second plane, including LSB data can be generated according to a transpose of the convolutional kernel (a 1×2 convolutional kernel having a stride length of 2, such as [0 1].

The respective planes may be ingested into convolutional hardware (e.g., further eight-bit MACs to weight the ingested data according to a trained model). The outputs of the convolutional hardware may thereafter be summed to realize an operation on the input. However, a memory bus or other data pipeline at the output of the convolutional hardware may be configured to receive the summation. For example, continuing the prior example, a sixteen-bit input multiplied with sixteen-bit weights can generate a thirty-two-bit value, whereas a system designed for eight-bit inputs may be configured to receive 16 bits at an output. Accordingly, the data can be stored according to a data structure configured to operate with a predefined pipeline that can also store an expected range of data. Such a data structure can aid storage of thirty-two-bit data in sixteen-bits without a loss of precision (or with a marginal loss of precision). For example, where the information is integer information, the data can be stored as two's compliment with a ten-bit exponent and a five-bit mantissa.

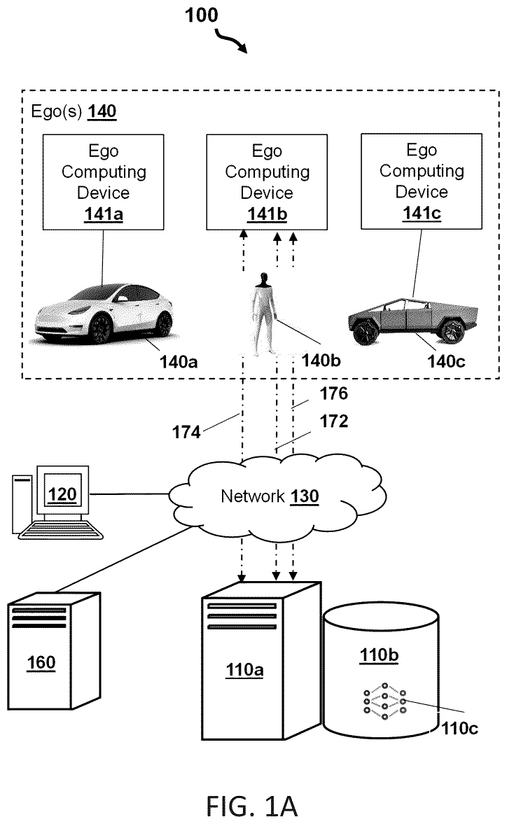

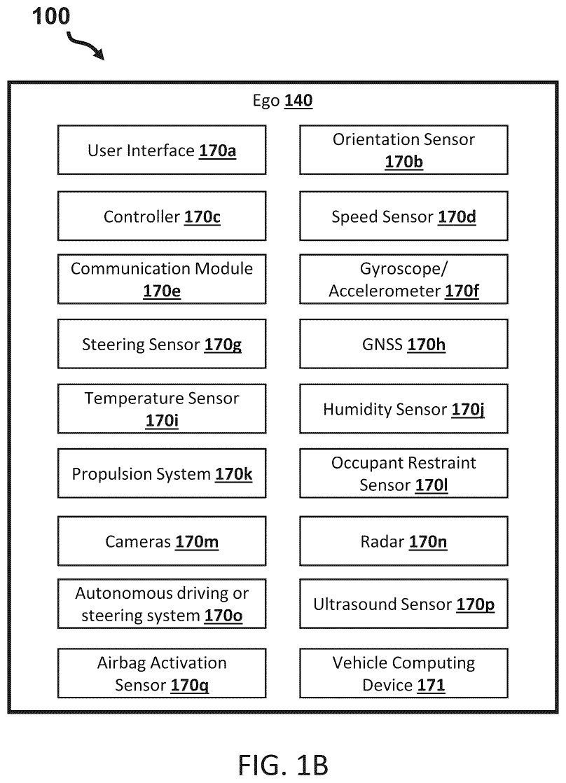

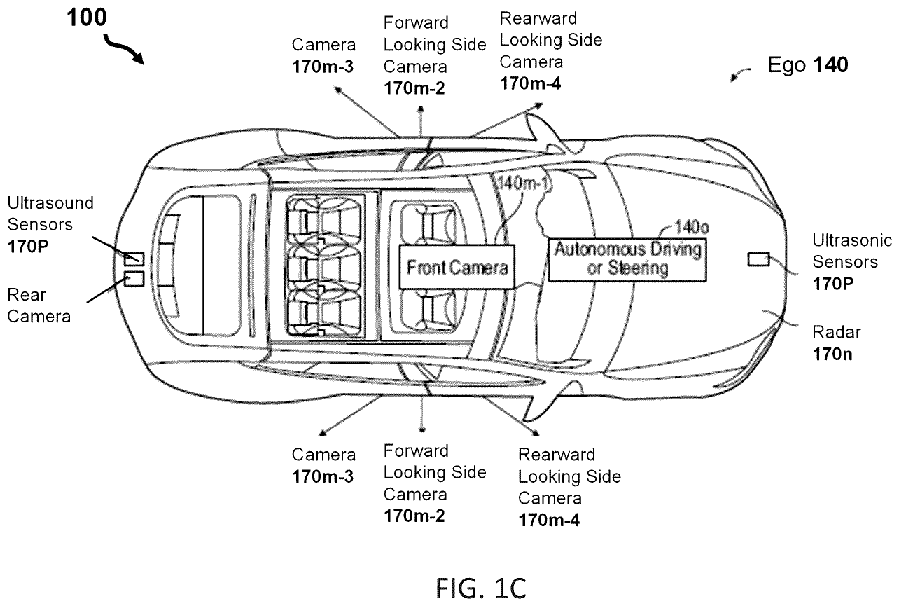

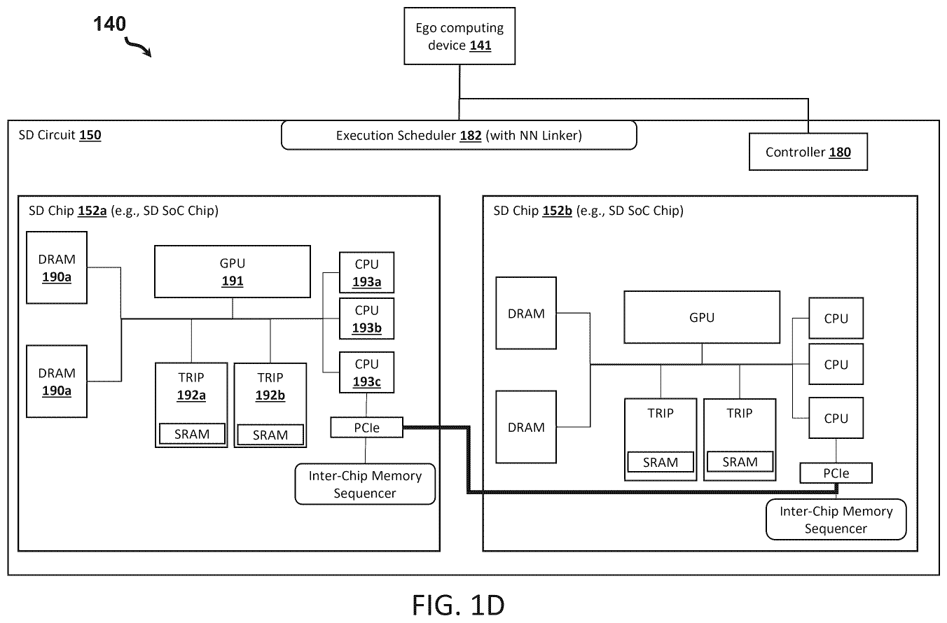

FIG. 1A is a non-limiting example of components of a system 100 in which the methods and systems discussed herein can be implemented. For instance, an analytics server may train an AI model and use the trained AI model to generate an occupancy dataset and/or map for one or more egos. FIG. 1A illustrates components of an AI-enabled visual data analysis system 100. The system 100 may include an analytics server 110a, a system database 110b, an administrator computing device 120, egos 140a-140b (collectively ego(s) 140), ego computing devices 141a-c (collectively ego computing devices 141), and a server 160. The system 100 is not confined to the components described herein and may include additional or other components not shown for brevity, which are to be considered within the scope of the embodiments described herein.

The above-mentioned components may be connected through a network 130. Examples of the network 130 may include, but are not limited to, private or public LAN, WLAN, MAN, WAN, and the Internet. The network 130 may include wired and/or wireless communications according to one or more standards and/or via one or more transport mediums.

The communication over the network 130 may be performed in accordance with various communication protocols such as Transmission Control Protocol and Internet Protocol (TCP/IP), User Datagram Protocol (UDP), and IEEE communication protocols. In one example, the network 130 may include wireless communications according to Bluetooth specification sets or another standard or proprietary wireless communication protocol. In another example, the network 130 may also include communications over a cellular network, including, for example, a GSM (Global System for Mobile Communications), CDMA (Code Division Multiple Access), or an EDGE (Enhanced Data for Global Evolution) network.

The system 100 illustrates an example of a system architecture and components that can be used to train and execute one or more AI models, such the AI model(s) 110c. Specifically, as depicted in FIG. 1A and described herein, the analytics server 110a can use the methods discussed herein to train the AI model(s) 110c using data retrieved from the egos 140 (e.g., by using data streams 172 and 174). When the AI model(s) 110c have been trained, each of the egos 140 may have access to and execute the trained AI model(s) 110c. For instance, the vehicle 140a having the ego computing device 141a may transmit its camera feed to the trained AI model(s) 110c and may determine the occupancy status of its surroundings (e.g., data stream 174). Moreover, the data ingested and/or predicted by the AI model(s) 110c with respect to the egos 140 (at inference time) may also be used to improve the AI model(s) 110c. Therefore, the system 100 depicts a continuous loop that can periodically improve the accuracy of the AI model(s) 110c. Moreover, the system 100 depicts a loop in which data received the egos 140 can be used to at training phase in addition to the inference phase.

The analytics server 110a may be configured to collect, process, and analyze navigation data (e.g., images captured while navigating) and various sensor data collected from the egos 140. The collected data may then be processed and prepared into a training dataset. The training dataset may then be used to train one or more AI models, such as the AI model 110c. The analytics server 110a may also be configured to collect visual data from the egos 140. Using the AI model 110c (trained using the methods and systems discussed herein), the analytics server 110a may generate a dataset and/or an occupancy map for the egos 140. The analytics server 110a may display the occupancy map on the egos 140 and/or transmit the occupancy map/dataset to the ego computing devices 141, the administrator computing device 120, and/or the server 160.

In FIG. 1A, the AI model 110c is illustrated as a component of the system database 110b, but the AI model 110c may be stored in a different or a separate component, such as cloud storage or any other data repository accessible to the analytics server 110a.

The analytics server 110a may also be configured to display an electronic platform illustrating various training attributes for training the AI model 110c. The electronic platform may be displayed on the administrator computing device 120, such that an analyst can monitor the training of the AI model 110c. An example of the electronic platform generated and hosted by the analytics server 110a may be a web-based application or a website configured to display the training dataset collected from the egos 140 and/or training status/metrics of the AI model 110c.

The analytics server 110a may be any computing device comprising a processor and non-transitory machine-readable storage capable of executing the various tasks and processes described herein. Non-limiting examples of such computing devices may include workstation computers, laptop computers, server computers, and the like. While the system 100 includes a single analytics server 110a, the system 100 may include any number of computing devices operating in a distributed computing environment, such as a cloud environment.

The egos 140 may represent various electronic data sources that transmit data associated with their previous or current navigation sessions to the analytics server 110a. The egos 140 may be any apparatus configured for navigation, such as a vehicle 140a and/or a truck 140c. The egos 140 are not limited to being vehicles and may include robotic devices as well. For instance, the egos 140 may include a robot 140b, which may represent a general purpose, bipedal, autonomous humanoid robot capable of navigating various terrains. The robot 140b may be equipped with software that enables balance, navigation, perception, or interaction with the physical world. The robot 140b may also include various cameras configured to transmit visual data to the analytics server 110a.

Even though referred to herein as an “ego,” the egos 140 may or may not be autonomous devices configured for automatic navigation. For instance, in some embodiments, the ego 140 may be controlled by a human operator or by a remote processor. The ego 140 may include various sensors, such as the sensors depicted in FIG. 1B. The sensors may be configured to collect data as the egos 140 navigate various terrains (e.g., roads). The analytics server 110a may collect data provided by the egos 140. For instance, the analytics server 110a may obtain navigation session and/or road/terrain data (e.g., images of the egos 140 navigating roads) from various sensors, such that the collected data is eventually used by the AI model 110c for training purposes.

As used herein, a navigation session corresponds to a trip where egos 140 travel a route, regardless of whether the trip was autonomous or controlled by a human. In some embodiments, the navigation session may be for data collection and model training purposes. However, in some other embodiments, the egos 140 may refer to a vehicle purchased by a consumer and the purpose of the trip may be categorized as everyday use. The navigation session may start when the egos 140 move from a non-moving position beyond a threshold distance (e.g., 0.1 mi, 100 ft) or exceed a threshold speed (e.g., over 0 mph, over 1 mph, over 5 mph). The navigation session may end when the egos 140 are returned to a non-moving position and/or are turned off (e.g., when a driver exits a vehicle).

The egos 140 may represent a collection of egos monitored by the analytics server 110a to train the AI model(s) 110c. For instance, a driver for the vehicle 140a may authorize the analytics server 110a to monitor data associated with their respective vehicle. As a result, the analytics server 110a may utilize various methods discussed herein to collect sensor/camera data and generate a training dataset to train the AI model(s) 110c accordingly. The analytics server 110a may then apply the trained AI model(s) 110c to analyze data associated with the egos 140 and to predict an occupancy map for the egos 140. Moreover, additional/ongoing data associated with the egos 140 can also be processed and added to the training dataset, such that the analytics server 110a re-calibrates the AI model(s) 110c accordingly. Therefore, the system 100 depicts a loop in which navigation data received from the egos 140 can be used to train the AI model(s) 110c. The egos 140 may include processors that execute the trained AI model(s) 110c for navigational purposes. While navigating, the egos 140 can collect additional data regarding their navigation sessions, and the additional data can be used to calibrate the AI model(s) 110c. That is, the egos 140 represent egos that can be used to train, execute/use, and re-calibrate the AI model(s) 110c. In a non-limiting example, the egos 140 represent vehicles purchased by customers that can use the AI model(s) 110c to autonomously navigate while simultaneously improving the AI model(s) 110c.

The egos 140 may be equipped with various technology allowing the egos to collect data from their surroundings and (possibly) navigate autonomously. For instance, the egos 140 may be equipped with inference chips to run self-driving software.

Various sensors for each ego 140 may monitor and transmit the collected data associated with different navigation sessions to the analytics server 110a. FIGS. 1B-1C illustrate block diagrams of sensors integrated within the egos 140, according to an embodiment. The number and position of each sensor discussed with respect to FIGS. 1B-1C may depend on the type of ego 140 discussed in FIG. 1A. For instance, the robot 140b may include different sensors than the vehicle 140a or the truck 140c. For instance, the robot 140b may not include the airbag activation sensor 170q. Moreover, the sensors of the vehicle 140a and the truck 140c may be positioned differently than illustrated in FIG. 1C.

As discussed herein, various sensors integrated within each ego 140 may be configured to measure various data associated with each navigation session. The analytics server 110a may periodically collect data monitored and collected by these sensors, wherein the data is processed in accordance with the methods described herein and used to train the AI model 110c and/or execute the AI model 110c to generate the occupancy map.

The egos 140 may include a user interface 170a. The user interface 170a may refer to a user interface of an ego computing device (e.g., the ego computing devices 141 in FIG. 1A). The user interface 170a may be implemented as a display screen integrated with or coupled to the interior of a vehicle, a heads-up display, a touchscreen, or the like. The user interface 170a may include an input device, such as a touchscreen, knobs, buttons, a keyboard, a mouse, a gesture sensor, a steering wheel, or the like. In various embodiments, the user interface 170a may be adapted to provide user input (e.g., as a type of signal and/or sensor information) to other devices or sensors of the egos 140 (e.g., sensors illustrated in FIG. 1B), such as a controller 170c.

The user interface 170a may also be implemented with one or more logic devices that may be adapted to execute instructions, such as software instructions, implementing any of the various processes and/or methods described herein. For example, the user interface 170a may be adapted to form communication links, transmit and/or receive communications (e.g., sensor signals, control signals, sensor information, user input, and/or other information), or perform various other processes and/or methods. In another example, the driver may use the user interface 170a to control the temperature of the egos 140 or activate its features (e.g., autonomous driving or steering system 1700). Therefore, the user interface 170a may monitor and collect driving session data in conjunction with other sensors described herein. The user interface 170a may also be configured to display various data generated/predicted by the analytics server 110a and/or the AI model 110c.

An orientation sensor 170b may be implemented as one or more of a compass, float, accelerometer, and/or other digital or analog device capable of measuring the orientation of the egos 140 (e.g., magnitude and direction of roll, pitch, and/or yaw, relative to one or more reference orientations such as gravity and/or magnetic north). The orientation sensor 170b may be adapted to provide heading measurements for the egos 140. In other embodiments, the orientation sensor 170b may be adapted to provide roll, pitch, and/or yaw rates for the egos 140 using a time series of orientation measurements. The orientation sensor 170b may be positioned and/or adapted to make orientation measurements in relation to a particular coordinate frame of the egos 140.

A controller 170c may be implemented as any appropriate logic device (e.g., processing device, microcontroller, processor, application-specific integrated circuit (ASIC), field programmable gate array (FPGA), memory storage device, memory reader, or other device or combinations of devices) that may be adapted to execute, store, and/or receive appropriate instructions, such as software instructions implementing a control loop for controlling various operations of the egos 140. Such software instructions may also implement methods for processing sensor signals, determining sensor information, providing user feedback (e.g., through user interface 170a), querying devices for operational parameters, selecting operational parameters for devices, or performing any of the various operations described herein.

A communication module 170e may be implemented as any wired and/or wireless interface configured to communicate sensor data, configuration data, parameters, and/or other data and/or signals to any feature shown in FIG. 1A (e.g., analytics server 110a). As described herein, in some embodiments, communication module 170e may be implemented in a distributed manner such that portions of communication module 170e are implemented within one or more elements and sensors shown in FIG. 1B. In some embodiments, the communication module 170e may delay communicating sensor data. For instance, when the egos 140 do not have network connectivity, the communication module 170e may store sensor data within temporary data storage and transmit the sensor data when the egos 140 are identified as having proper network connectivity.

A speed sensor 170d may be implemented as an electronic pitot tube, metered gear or wheel, water speed sensor, wind speed sensor, wind velocity sensor (e.g., direction and magnitude), and/or other devices capable of measuring or determining a linear speed of the egos 140 (e.g., in a surrounding medium and/or aligned with a longitudinal axis of the egos 140) and providing such measurements as sensor signals that may be communicated to various devices.

A gyroscope/accelerometer 170f may be implemented as one or more electronic sextants, semiconductor devices, integrated chips, accelerometer sensors, or other systems or devices capable of measuring angular velocities/accelerations and/or linear accelerations (e.g., direction and magnitude) of the egos 140, and providing such measurements as sensor signals that may be communicated to other devices, such as the analytics server 110a. The gyroscope/accelerometer 170f may be positioned and/or adapted to make such measurements in relation to a particular coordinate frame of the egos 140. In various embodiments, the gyroscope/accelerometer 170f may be implemented in a common housing and/or module with other elements depicted in FIG. 1B to ensure a common reference frame or a known transformation between reference frames.

A global navigation satellite system (GNSS) 170h may be implemented as a global positioning satellite receiver and/or another device capable of determining absolute and/or relative positions of the egos 140 based on wireless signals received from space-born and/or terrestrial sources, for example, and capable of providing such measurements as sensor signals that may be communicated to various devices. In some embodiments, the GNSS 170h may be adapted to determine the velocity, speed, and/or yaw rate of the egos 140 (e.g., using a time series of position measurements), such as an absolute velocity and/or a yaw component of an angular velocity of the egos 140.

A temperature sensor 170i may be implemented as a thermistor, electrical sensor, electrical thermometer, and/or other devices capable of measuring temperatures associated with the egos 140 and providing such measurements as sensor signals. The temperature sensor 170i may be configured to measure an environmental temperature associated with the egos 140, such as a cockpit or dash temperature, for example, which may be used to estimate a temperature of one or more elements of the egos 140.

A humidity sensor 170j may be implemented as a relative humidity sensor, electrical sensor, electrical relative humidity sensor, and/or another device capable of measuring a relative humidity associated with the egos 140 and providing such measurements as sensor signals.

A steering sensor 170g may be adapted to physically adjust a heading of the egos 140 according to one or more control signals and/or user inputs provided by a logic device, such as controller 170c. Steering sensor 170g may include one or more actuators and control surfaces (e.g., a rudder or other type of steering or trim mechanism) of the egos 140, and may be adapted to physically adjust the control surfaces to a variety of positive and/or negative steering angles/positions. The steering sensor 170g may also be adapted to sense a current steering angle/position of such steering mechanism and provide such measurements.

A propulsion system 170k may be implemented as a propeller, turbine, or other thrust-based propulsion system, a mechanical wheeled and/or tracked propulsion system, a wind/sail-based propulsion system, and/or other types of propulsion systems that can be used to provide motive force to the egos 140. The propulsion system 170k may also monitor the direction of the motive force and/or thrust of the egos 140 relative to a coordinate frame of reference of the egos 140. In some embodiments, the propulsion system 170k may be coupled to and/or integrated with the steering sensor 170g.

An occupant restraint sensor 170l may monitor seatbelt detection and locking/unlocking assemblies, as well as other passenger restraint subsystems. The occupant restraint sensor 170l may include various environmental and/or status sensors, actuators, and/or other devices facilitating the operation of safety mechanisms associated with the operation of the egos 140. For example, occupant restraint sensor 170l may be configured to receive motion and/or status data from other sensors depicted in FIG. 1B. The occupant restraint sensor 170l may determine whether safety measurements (e.g., seatbelts) are being used.

Cameras 170m may refer to one or more cameras integrated within the egos 140 and may include multiple cameras integrated (or retrofitted) into the ego 140, as depicted in FIG. 1C. The cameras 170m may be interior- or exterior-facing cameras of the egos 140. For instance, as depicted in FIG. 1C, the egos 140 may include one or more interior-facing cameras that may monitor and collect footage of the occupants of the egos 140. The egos 140 may include eight exterior facing cameras. For example, the egos 140 may include a front camera 170m-1, a forward-looking side camera 170m-2, a forward-looking side camera 170m-3, a rearward looking side camera 170m-4 on each front fender, a camera 170m-5 (e.g., integrated within a B-pillar) on each side, and a rear camera 170m-6.

Referring to FIG. 1B, a radar 170n and ultrasound sensors 170p may be configured to monitor the distance of the egos 140 to other objects, such as other vehicles or immobile objects (e.g., trees or garage doors). The egos 140 may also include an autonomous driving or steering system 1700 configured to use data collected via various sensors (e.g., radar 170n, speed sensor 170d, and/or ultrasound sensors 170p) to autonomously navigate the ego 140.

Therefore, autonomous driving or steering system 1700 may analyze various data collected by one or more sensors described herein to identify driving data. For instance, autonomous driving or steering system 1700 may calculate a risk of forward collision based on the speed of the ego 140 and its distance to another vehicle on the road. The autonomous driving or steering system 1700 may also determine whether the driver is touching the steering wheel. The autonomous driving or steering system 1700 may transmit the analyzed data to various features discussed herein, such as the analytics server.

An airbag activation sensor 170q may anticipate or detect a collision and cause the activation or deployment of one or more airbags. The airbag activation sensor 170q may transmit data regarding the deployment of an airbag, including data associated with the event causing the deployment.

Referring back to FIG. 1A, the administrator computing device 120 may represent a computing device operated by a system administrator. The administrator computing device 120 may be configured to display data retrieved or generated by the analytics server 110a (e.g., various analytic metrics and risk scores), wherein the system administrator can monitor various models utilized by the analytics server 110a, review feedback, and/or facilitate the training of the AI model(s) 110c maintained by the analytics server 110a.

The ego(s) 140 may be any device configured to navigate various routes, such as the vehicle 140a or the robot 140b. As discussed with respect to FIGS. 1B-1C, the ego 140 may include various telemetry sensors. The egos 140 may also include ego computing devices 141. Specifically, each ego may have its own ego computing device 141. For instance, the truck 140c may have the ego computing device 141c. For brevity, the ego computing devices are collectively referred to as the ego computing device(s) 141. The ego computing devices 141 may control the presentation of content on an infotainment system of the egos 140, process commands associated with the infotainment system, aggregate sensor data, manage communication of data to an electronic data source, receive updates, and/or transmit messages. In one configuration, the ego computing device 141 communicates with an electronic control unit. In another configuration, the ego computing device 141 is an electronic control unit. The ego computing devices 141 may comprise a processor and a non-transitory machine-readable storage medium capable of performing the various tasks and processes described herein. For example, the AI model(s) 110c described herein may be stored and performed (or directly accessed) by the ego computing devices 141. Non-limiting examples of the ego computing devices 141 may include a vehicle multimedia and/or display system.

In one example of how the AI model(s) 110c can be trained, the analytics server 110a may collect data from egos 140 to train the AI model(s) 110c. Before executing the AI model(s) 110c to generate/predict an occupancy dataset, the analytics server 110a may train the AI model(s) 110c using various methods. The training allows the AI model(s) 110c to ingest data from one or more cameras of one or more egos 140 (without the need to receive radar data) and predict occupancy data for the ego's surroundings. The operation described in this example may be executed by any number of computing devices operating in the distributed computing system described in FIGS. 1A-1C (e.g., a processor of the egos 140).

The analytics server 110a may generate, using a sensor of an ego 140, a first dataset having a first set of data points where each data point within the first set of data points corresponds to a location and a sensor attribute of at least one voxel of space around the egos 140, the sensor attribute indicating whether the at least one voxel is occupied by an object having mass.

To train the AI model(s) 110c, the analytics server 110a may first employ one or more of the egos 140 to drive a particular route. While driving, the egos 140 may use one or more of their sensors (including one or more cameras) to generate navigation session data. For instance, the one or more of the egos 140 equipped with various sensors can navigate the designated route. As the one or more of the egos 140 traverse the terrain, their sensors may capture continuous (or periodic) data of their surroundings. The sensors may indicate an occupancy status of the one or more egos' 140 surroundings. For instance, the sensor data may indicate various objects having mass in the surroundings of the one or more of the egos 140 as they navigate their route.

The analytics server 110a may generate a first dataset using the sensor data received from the one or more of the egos 140. The first dataset may indicate the occupancy status of different voxels within the surroundings of the one or more of the egos 140. As used herein in some embodiments, a voxel is a three-dimensional pixel, forming a building block of the surroundings of the one or more of the egos 140. Within the first dataset, each voxel may encapsulate sensor data indicating whether a mass was identified for that particular voxel. Mass, as used herein, may indicate or represent any object identified using the sensor. For instance, in some embodiments, the egos 140 may be equipped with an emitter that identifies a mass by emitting pulses and measuring the time it takes for these pulses to travel to an object (having mass) and back. These sensor systems may operate based on the principle of measuring the distance between the emitter/sensor and objects in its field of view. This information, combined with other sensor data, may be analyzed to identify and characterize different masses or objects within the surroundings of the one or more of the egos 140.

Various additional data may be used to indicate whether a voxel of the one or more egos' 140 surroundings is occupied by an object having mass or not. For instance, in some embodiments, a digital map of the surroundings (e.g., a digital map of the route being traversed by the ego) of the one or more egos 140 may be used to determine the occupancy status of each voxel.

In operation, as the one or more egos 140 navigate, their sensors collect data and transmit the data to the analytics server 110a, as depicted in the data stream 176. For instance, the ego 140 computing devices 141 may transmit sensor data to the analytics server 110a using the data stream 176.

The analytics server 110a may generate, using a camera of the ego 140, a second dataset having a second set of data points where each data point within the second set of data points corresponds to a location and an image attribute of at least one voxel of space around the ego 140.

The analytics server 110a may receive a camera feed of the one or more egos 140 navigating the same route as in the first step. In some embodiments, the analytics server 110a may simultaneously (or contemporaneously) perform the first step and the second step. Alternatively, two (or more) different egos 140 may navigate the same route where one ego transmits its sensor data, and the second ego 140 transmits its camera feed.

The one or more egos 140 may include one or more high-resolution cameras that capture a continuous stream of visual data from the surroundings of the one or more egos 140 as the one or more egos 140 navigate through the route. The analytics server 110a may then generate a second dataset using the camera feed where visual elements/depictions of different voxels of the one or more egos' 140 surroundings are included within the second dataset.

In operation, as the one or more egos 140 navigate, their cameras collect data and transmit the data to the analytics server 110a, as depicted in the data stream 172. For instance, the ego computing devices 141 may transmit image data to the analytics server 110a using the data stream 172.

The analytics server 110a may train an AI model using the first and second datasets, whereby the AI model 110c correlates each data point within the first set of data points with a corresponding data point within the second set of data points, using each data point's respective location to train itself, wherein, once trained, the AI model 110c is configured to receive a camera feed from a new ego 140 and predict an occupancy status of at least one voxel of the camera feed.

Using the first and second datasets, the analytics server 110a may train the AI model(s) 110c, such that the AI model(s) 110c may correlate different visual attributes of a voxel (within the camera feed within the second dataset) to an occupancy status of that voxel (within the first dataset). In this way, once trained, the AI model(s) 110c may receive a camera feed (e.g., from a new ego 140) without receiving sensor data and then determine each voxel's occupancy status for the new ego 140.

The analytics server 110a may generate a training dataset that includes the first and second datasets. The analytics server 110a may use the first dataset as ground truth. For instance, the first dataset may indicate the different location of voxels and their occupancy status. The second dataset may include a visual (e.g., a camera feed) illustration of the same voxel. Using the first dataset, the analytics server 110a may label the data, such that data record(s) associated with each voxel corresponding to an object are indicated as having a positive occupancy status.

The labeling of the occupancy status of different voxels may be performed automatically and/or manually. For instance, in some embodiments, the analytics server 110a may use human reviewers to label the data. For instance, as discussed herein, the camera feed from one or more cameras of a vehicle may be shown on an electronic platform to a human reviewer for labeling. Additionally or alternatively, the data in its entirety may be ingested by the AI model(s) 110c where the AI model(s) 110c identifies corresponding voxels, analyzes the first digital map, and correlates the image(s) of each voxel to its respective occupancy status.

Using the ground truth, the AI model(s) 110c may be trained, such that each voxel's visual elements are analyzed and correlated to whether that voxel was occupied by a mass. Therefore, the AI model 110c may retrieve the occupancy status of each voxel (using the first dataset) and use the information as ground truth. The AI model(s) 110c may also retrieve visual attributes of the same voxel using the second dataset.

In some embodiments, the analytics server 110a may use a supervised method of training. For instance, using the ground truth and the visual data received, the AI model(s) 110c may train itself, such that it can predict an occupancy status for a voxel using only an image of that voxel. As a result, when trained, the AI model(s) 110c may receive a camera feed, analyze the camera feed, and determine an occupancy status for each voxel within the camera feed (without the need to use a radar).

The analytics server 110a may feed the series of training datasets to the AI model(s) 110c and obtain a set of predicted outputs (e.g., predicted occupancy status). The analytics server 110a may then compare the predicted data with the ground truth data to determine a difference and train the AI model(s) 110c by adjusting the AI model's 110c internal weights and parameters proportional to the determined difference according to a loss function. The analytics server 110a may train the AI model(s) 110c in a similar manner until the trained AI model's 110c prediction is accurate to a certain threshold (e.g., recall or precision).

Additionally or alternatively, the analytics server 110a may use an unsupervised method where the training dataset is not labeled. Because labeling the data within the training dataset may be time-consuming and may require excessive computing power, the analytics server 110a may utilize unsupervised training techniques to train the AI model 110c.

After the AI model 110c is trained, it can be used by an ego 140 to predict occupancy data of the one or more egos' 140 surroundings. For instance, the AI model(s) 110c may divide the ego's surroundings into different voxels and predict an occupancy status for each voxel. In some embodiments, the AI model(s) 110c (or the analytics server 110a using the data predicted using the AI model 110c) may generate an occupancy map or occupancy network representing the surroundings of the one or more egos 140 at any given time.

In another example of how the AI model(s) 110c may be used, after training the AI model(s) 110c, analytics server 110a (or a local chip of an ego 140) may collect data from an ego (e.g., one or more of the egos 140) to predict an occupancy dataset for the one or more egos 140. This example describes how the AI model(s) 110c can be used to predict occupancy data in real-time or near real-time for one or more egos 140. This configuration may have a processor, such as the analytics server 110a, execute the AI model. However, one or more actions may be performed locally via, for example, a chip located within the one or more egos 140. In operation, the AI model(s) 110c may be executed via an ego 140 locally, such that the results can be used to autonomously navigate itself.

The processor may input, using a camera of an ego object 140, image data of a space around the ego object 140 into an AI model 110c. The processor may collect and/or analyze data received from various cameras of one or more egos 140 (e.g., exterior-facing cameras). In another example, the processor may collect and aggregate footage recorded by one or more cameras of the egos 140. The processor may then transmit the footage to the AI model(s) 110c trained using the methods discussed herein.

The processor may predict, by executing the AI model 110c, an occupancy attribute of a plurality of voxels. The AI model(s) 110c may use the methods discussed herein to predict an occupancy status for different voxels surrounding the one or more egos 140 using the image data received.

The processor may generate a dataset based on the plurality of voxels and their corresponding occupancy attribute. The analytics server 110a may generate a dataset that includes the occupancy status of different voxels in accordance with their respective coordinate values. The dataset may be a query-able dataset available to transmit the predicted occupancy status to different software modules.

In operation, the one or more egos 140 may collect image data from their cameras and transmit the image data to the processor (placed locally on the one or more egos 140) and/or the analytics server 110a, as depicted in the data stream 172. The processor may then execute the AI model(s) 110c to predict occupancy data for the one or more egos 140. If the prediction is performed by the analytics server 110a, then the occupancy data can be transmitted to the one or more egos 140 using the data stream 174. If the processor is placed locally within the one or more egos 140, then the occupancy data is transmitted to the ego computing devices 141 (not shown in FIG. 1A).

Using the methods discussed herein, the training of the AI model(s) 110c can be performed such that the execution of the AI model(s) 110c may be performed locally on any of the egos 140 (at inference time). The data collected (e.g., navigational data collected during the navigation of the egos 140, such as image data of a trip) can then be fed back into the AI model(s) 110c, such that the additional data can improve the AI model(s) 110c.

FIG. 1D shows certain hardware and software components of the ego 140 for performing full or partial self-driving (SD) operations, according to an embodiment. The ego 140 comprises an SD circuit 150 and the ego computing device 141, which may include the same or different components of the SD circuit 150. The SD circuit 150 includes SD chips 152a-152b (generally referred to as SD chip 152), such as system-on-chip (SoC) integrated circuit chips. Each SD chip 152 includes non-transitory machine-readable memories, such as Dynamic Random-Access Memories (DRAMs) 190a-190b (generally referred to as DRAMs 190) and SRAMs. The SD chip 152 further includes various types of processing units, including a GPU 191, central processing units (CPUs) 193a-193c (generally referred to as CPUs 193), and specially designed Tera-op, Reliable, Intelligently adaptive Processing System (TRIP) processing units 192a-192b (generally referred to as TRIP units 192).

As mentioned, the ego computing device 141 may execute various software programming operations for managing operations of the SD circuit 150 (or other hardware), which may include execution instructions for applying the neural network architecture on the types of sensor data from the sensors of the ego 140. The operations of the ego computing device 141 may further include, for example, compiling execution instructions for the SD circuit 150 to perform certain functions of the neural network architecture or for operating the ego 140.

In the example embodiment, the SD circuit 150 comprises two SD chips 152a-152b. In many cases, the SD chips 152 function in a redundancy mode or failover mode of operation, where a first SD chip 152a functions as a primary chip and a second SD chip 152b functions as a secondary chip. For example, the first SD chip 152a is prioritized to execute most of the executable instructions, and the second SD chip 152b is invoked to operate as failover or redundancy in the event of problems with the first SD chip 152a.

The ego 140, however, may comprise an SD circuit 150 that operates in an extended compute mode that balances the execution instruction pipelines amongst SD chips 152. As an example, the ego computing device 141 executes software routines for compiling the execution instructions to be performed by the processing units 191-193 of the SD chips 152, and distributing the execution instructions to the optimal hardware components of the SD circuit 150.

In some embodiments, the ego 140 comprises a controller 180 that performs various operations for managing the SD circuit 150. The controller 180 may perform various functions according to, for example, instructions from the ego computing device 141 (or other component of the ego 140) or configuration inputs from an administrative user. For instance, the controller 180 toggles, configures, or otherwise instructs the SD circuit 150 to operate in the various operational modes. In some circumstances, for example, the controller 180 instructs the SD circuit 150 to operate in an extended compute mode in which the first SD chip 152a executes a first instruction partition of the execution instructions and the second SD chip 152b executes a second instruction partition. As another example, in some circumstances, the controller 180 instructs the SD circuit 150 to operate in a failover mode in which the second SD chip 152b executes the execution instructions when the first SD chip 152a fails.

The SD chip 152 includes one or more DRAMs 190 or other types of non-transitory memories for storing data inputs for the SD chip 152. The data inputs may be stored in the DRAM 190 for the processing units to reference for various computations. In some configurations, the TRIP units 192 include SRAMs, such that the SD chip 152 moves the data from a DRAM 190 for storage into the SRAM of the TRIP unit 192. The TRIP unit 192 executes the computation according to the execution instructions and moves the data back to the DRAM 190 or other destination of the SD circuit 150.

The SD chip 152 includes various types of processing units, which may include any hardware integrated circuit (IC) processor device capable of performing the various processes and tasks described herein. Non-limiting examples of the types of processing units include GPUs 191, CPUs 193, TRIP units 192, microcontrollers, ALUs, ASICs, and FPGAs, among others. The processing units may perform the computational functions of the programming layers defining the neural network architectures or sub-architectures. The compilers output the execution instructions representing the operations of the neural network architecture, executed by the ego computing device 141 (or other component of the ego 140).

The TRIP units 192 are designed specifically for the neural network operations, beneficially focusing on improvements to, for example, optimizing power and performance (e.g., low latency). The TRIP units 192 include hardware IC devices (e.g., microcontrollers, ALUs, ASICs, FPGAs, processor devices) designed for fast operations when processing neural network architectures. For instance, as transformers and other types of neural network modeling techniques grow more popular, typical processing units (e.g., CPUs, GPUs) may be unnecessarily slow due to a theory of design intended for broader implementation use cases. For instance, a neural network architecture, sub-neural network, or child neural network performs computer vision or object recognition by implementing various GPTs (or other types of transforms) on the image sensor data, beneficially replacing previous techniques for post-processing of vision neural networks. The TRIP unit 192 is designed specifically for neural network operations allowing the GPT transformers to run natively in the computing components of the ego 140, such that the TRIP units 192 provide faster and more efficient processing than traditional GPUs 191 or CPUs 193 executing similar GPT transformations. In this way, the TRIP units 192 mitigates or eliminates latency and improves overall efficiency, contributing to the ability of the ego 140 to make real-time decisions. Moreover, the structural design and design theory of the TRIP units 192 draw comparatively less power than traditional GPUs 191 or CPUs 193 when performing more sophisticated and complex functions of neural network architectures, such as the transformer networks (e.g., transformers).

The ego computing device 141 may execute software programming defining an execution scheduler 182, which determines the component of the SD circuit 150 that should execute particular operations of the neural network architecture. During training or inference time, the ego computing device 141 extracts features or tensors from the input sensor data gathered from the sensors of the ego 140, which the ego computing device 141 feeds to the various neural network architecture or sub-architectures for various operations (e.g., computer vision, object recognition). The ego computing device 141 applies a graph partitioner on the sensor data to generate data partitions or portions. The ego computing device 141 applies a set of compilers (not shown), which may logically form a compiler toolchain for the neural network architecture of the ego 140, for compiling and debugging the code for executing layers of the neural network architecture for sensor-data interpretation. Each compiler is used to transform the high-level programming language into machine code comprising execution instructions, executed by the hardware of the SD circuit 150. The compilers may be configured or optimized to compile the programming code according to the specific architectures or types of the processing units (e.g., CPU 193, GPU 191, or specialized TRIP unit 192 hardware) of the SD chips 152. The linker of the execution scheduler 182 may combine multiple compiled pieces of code (e.g., executable instructions) into one or more executable files or data stream for an execution schedule (not shown).

The linker and execution scheduler 182 obtains the set of execution instructions and maps the execution instructions into the hardware components (e.g., GPUs 191, TRIP units 192, CPUs 193) of the SD circuit 150 to perform the particular execution instructions. In some implementations, the linker of the execution scheduler 182 is trained to optimize the operations to be performed in the hardware components of the SD circuit 150. The linker is trained to determine or preconfigured with temporal or latency demands for the hardware components to perform the operations of the execution instructions. This is often possible because such performance-timing or latency metrics are known, essentially static, quickly calculated, or prestored. In this way, the linker maps the execution instructions to the components of the SD circuit 150 according to the minimized or optimized latency. Additionally or alternatively, the linker determines that hardware components of the SD circuit 150 should perform certain execution instructions based upon characteristics of the execution instructions (e.g., which compiler generated the machine code of the execution instruction). In this way, the linker maps the execution instructions to the processing units based upon the compiler that generated the particular execution instruction.

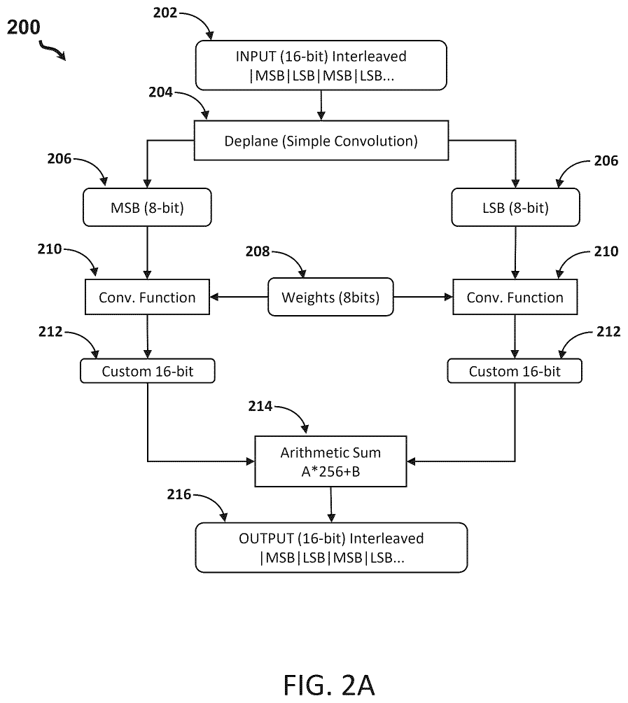

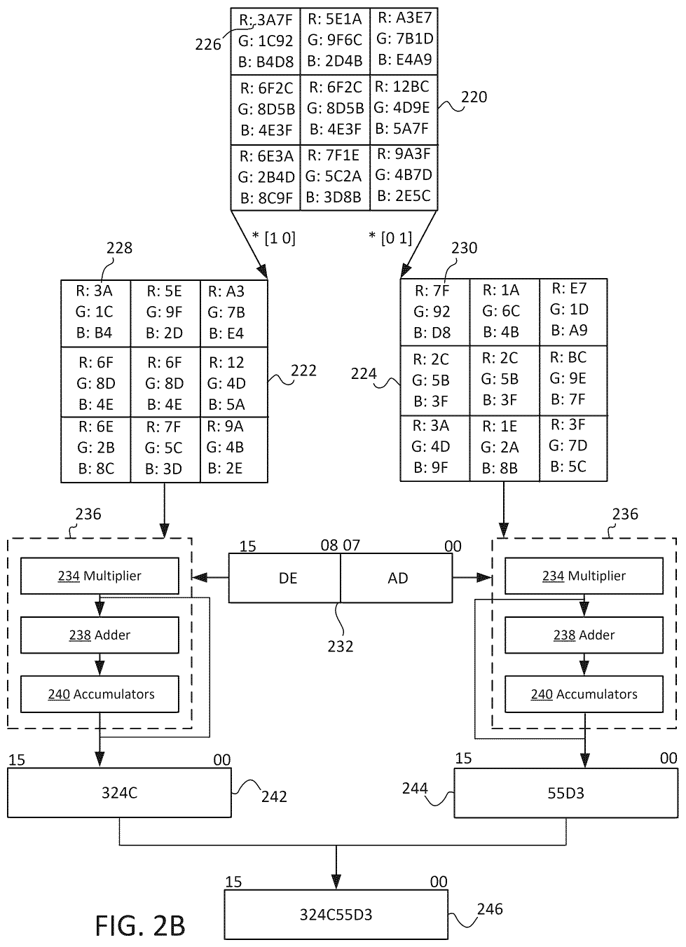

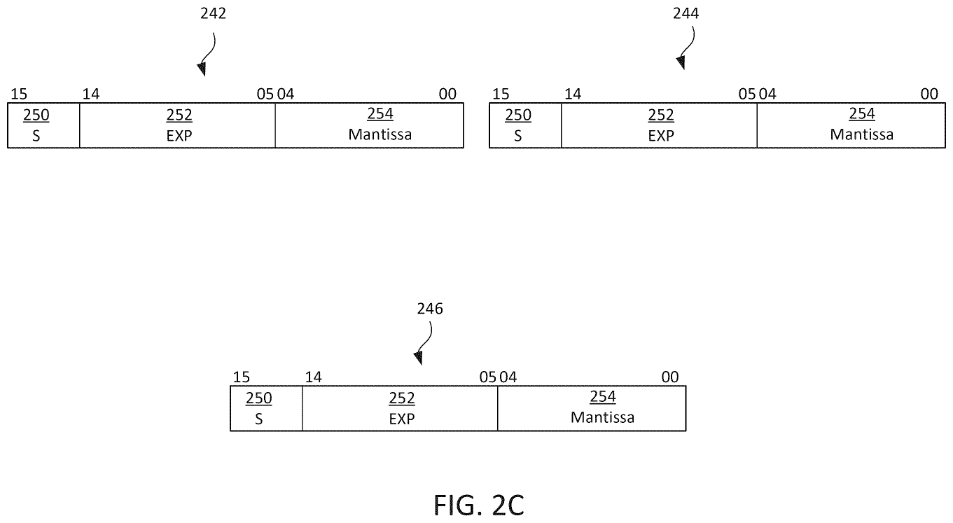

Referring now to FIG. 2A and others, an example flow diagram for a method 200 of performing convolution operations is provided, according to some embodiments. The method 200 may be performed by a compute device including one or more circuits, such as the SD circuit(s) 150 or SD chip(s) 152 of FIGS. 1A-1D. For example, the compute device can be integral to or coupled with the autonomous vehicle (e.g., ego 140) to cause the vehicle to execute autonomous navigational actions (e.g., according to wholly autonomous or semi-autonomous operation). The compute device can include various hardware multipliers of a fixed bit width (depicted according to a non-limiting example of 8-bits). For example, the hardware multipliers can be multiplier-accumulators (MACs) of a pipeline to implement one or more layers of a convolutional neural network (e.g., the AI models 110c). For example, the convolutional neural network can provide weights at the fixed bit-width of the multiplier-accumulators (MACs). According to the provided method 200, an augmented convolutional neural network including bit-augmented data (e.g., weights with a bit-width greater than the fixed bit width) can be executed. For example, the augmented convolutional neural network can be configured to process higher resolution data than a non-augmented neural network, which may aid an autonomous vehicle to perform navigational actions.

Generally, at operation 202, the compute device obtains input data (e.g., as an input data structure). For example, the input data structure can be received for one or more video frames. Data elements of the data structure (e.g., pixel values) can exceed a bit-width of a circuit of the compute device (e.g., the MACs). At operation 204, the compute device can generate further data structures from the input data structure. For example, the further data structures can include a portion of the data elements of the input data structure (e.g., one further data structure can include a most significant byte (MSB) of a data element and another data structure can include a least significant byte (LSB) of the same data element). At operation 206, the compute device obtains the portions of the data elements from the data structures. At operation 208, the compute device obtains bit-augmented weightings.

At operation 210, the compute device provides the portions of the data elements, separately, to circuitry configured to execute convolutional functions (e.g., the MACs). For example, one eight-bit MAC can receive a MSB of the first portion of the data element and a MSB of a weighting of the machine learning model; another eight-bit MAC (or a same MAC according to serial operation) can receive a LSB of the first portion of the data element and a LSB of the weighting model.

At operation 212, the circuitry configured to execute the convolutional functions (e.g., the MACs) outputs a product of the data elements portions and the weight portions (e.g., the LSB and the MSB). For example, sixteen-bit products can be provided for the two eight-bit inputs of operation 210. Accordingly, a first of the products can provide a sixteen-bit output based on the application of a convolutional function of the MSB with the weights of operation 208, and a second of the products can provide a sixteen-bit output based on the application of a convolutional function of the LSB with the weights of operation 208. According to various embodiments, the execution of operation 212 can generate a value in the accumulator register according to various formats such as integer representations (e.g., int15, int16, or int32), general floating point representations (e.g., float15, float16, or float32), or machine learning focused presentations (e.g., bfloat15, bfloat16, or bfloat32. In some embodiments, a custom or non-standard representation can be used. At operation 214, the products can be summed to generate a bit-augmented product. For example, the compute device can left-shift a MSB of the product (e.g., the product of the MSB weight and the MSB input) and sum the MSB of the product with the LSB of the products (e.g., the product of the LSB weight and the LSB input). At operation 216, the compute device outputs the bit-augmented product.

Referring again to operation 202, the compute device obtains an input data structure. The input data can be received from any sensor of the ego 140, such as a camera 170m. For example, the input data structure can include pixel data for an image (e.g., video feed). The pixel data can include one or more channels, such as an intensity channel for a monochromatic camera or various color channels (e.g., for a visible spectrum or other camera). An example of an input data structure including color channel data is provided hereinafter, at FIG. 2B. In some instances, the pixel data can relate to spatial information (e.g., of an occupancy grid for a computer vision system). The input data structure can be received according to a serial stream, or a parallel transfer (e.g., register transfer). For example, the input data structure can be received according to a parallel transfer equal to a bit-width of the MAC or other convolutional circuitry.

Referring again to operation 204, the compute device generates further data structures from the first data structure. The generation of the further data structures is sometimes referred to as “deplaning” wherein the various further data structures are sometimes referred to as planes. For example, for an input data structure including multiple color channels, the further data structures can include planes for each of the channels. For an input data structure including a bit-width exceeding a bit-width of the MACs or other convolutional hardware, the planes can include a MSB plane and a LSB plane. An example of such a data structure is provided hereinafter, at FIG. 2B.

In some embodiments, the planes can be provided as specified data structures. For example, and with further reference to FIG. 2B, the planes can be generated according to a convolution of a predefined kernel with the input data structure. The compute device can convolve a one-by-two (byte) kernel with the input data structure using the MACs, to provide deplaned data structures. For example, for an input data structure including sixteen-bit data elements, a convolution with a kernel of [0 1] (having bit values of 0000000011111111) can, according to a stride length of two (bytes), multiply every bit of an LSB by 1 and every bit of a MSB by zero, effectively generating a sparse output lacking MSB data. Another transposed predefined kernel of [1 0] can likewise generate a sparse output lacking LSB data. Thus, the generated data structures may be constituent data structures of the input data structure. In some embodiments, the sparse structure may be de-sparsified, either upon generation or a subsequent operation. In some embodiments, a subsequent operation can be configured to selectively process a sparse data structure (e.g., by dropping a lowermost bit of an address map, striding by two to ingest input data, intentionally overflowing or underflowing, or so forth). References to the one-by-two kernel (corresponding to inputs of sixteen bits for eight-bit hardware) are not intended to be limiting. Indeed, various embodiments, can include differently sized kernels, such as a one-by four-kernel for inputs of sixty-four bits for sixteen-bit hardware or n×m kernels for data having a row organization of n and a column organization of m (e.g., color data that spans rows). The computing device can select a stride to avoid overlap or stride gaps (sometimes referred to as underlap). For example, for the one-by-two kennels, the computing device can select a (vertical) stride of two and a step (sometimes referred as a horizontal stride) of one.

Referring again to operation 206, the compute device obtains the portions of the data elements from the data structures (e.g., from planes generated at operation 204). For example, the compute device can obtain the portions from a sparse (or de-sparsified data structure generated at operation 204). At operation 208, the compute device obtains weights of one or more layers of a machine learning model (also referred to as an AI model 110c, without limiting effect). For example, the obtained weight can exceed a bit-width of a hardware multiplier (e.g., MAC) or other convolutional hardware. However, the obtained weight may not exceed the combined bit-width of multiple instances of the of the convolutional hardware. For example, a machine learning model including twelve- or sixteen-bit hardware can be provided to two MACs (e.g., a MSB MAC and an LSB MAC). In some embodiments, the MSB MAC and the LSB MAC can be a same MAC provided, serially, a MSB and an LSB weight. In some embodiments, the MACs may be the same MACs used, at operation 204, to convolve the predefined kernels. In some embodiments, the MACs may be different, as in the case of a first portion of MACs allocated for a first purpose, a second portion of MACs allocated for a second purpose, and so on.

Referring again to operation 210, the convolutional hardware (e.g., at least a portion of the MACs referred to at operation 208) multiplies the input portions with the weight portions. In some embodiments, the operations of the present method 200 are repeated to convolve the weights across the input data structure. Such a convolution need not be constrained by the description of the convolution at operation 204. For example, the convolution may include stride overlap or underlap. Indeed, such convolution operations can be performed with regard to any of various layers of a machine learning models, which may incorporate different kernel sizes, padding schemes, and activation functions to extract meaningful features from the input data.

Referring again to operation 212, the output of the convolution operation is stored. The storage can refer to storage in an accumulator or other register of a MAC, or at a location external thereto (e.g., another register or memory location). For example, the output can be stored in a first format in the MAC and thereafter be stored in another format in another location. In some embodiments, the output is stored according to a two's complement or floating-point format. For example, the MAC (or other hardware in a pipeline downstream of the MAC) can be configured to process floating point data, wherein the input data structure consists of natural numbers (e.g., indicating occupancy, color data, or so forth). Accordingly, a register or associated hardware can be configured to receive data according to a predefined format (e.g., two's compliment), and the format can accord to at least a portion of the predefined format. In some embodiments, the format may differ in some respects from the predefined format. For example, the format can include a sign bit (even where all data is positive, as in the case of the natural numbers), exponent bit(s), and mantissa bit(s). An example format is provided hereinafter at FIG. 2C.

Referring again to operation 214, two of the outputs are summed to generate a bit augmented product. For example, a first of the outputs can refer to a product of the first portion of the weight and the first portion of the data elements; a second of the outputs can refer to a product of the second portion of the weight and the second portion of the data elements. The summation can be stored according to a same or different format as referred to with regards to operation 212. At operation 216, the output is provided. For example, the output can be provided according to a serial stream or a parallel transfer (e.g., register transfer). For example, the parallel transfer can be performed for a parallel width equal to width of the output (e.g., 16-bits) or can be another width, such as the input width (e.g., eight-bits), as provided by interleaved bytes.

FIG. 2B depicts data flow amongst components of a compute device performing the method 200, according to some embodiments. For example, the input data structure 220 can correspond to the input data structure of operation 202 of FIG. 2A. The input data structure 220 can include image data as received from a color image sensor. In some embodiments, the input data may be received at a substantial rate, such as twenty-four, thirty, thirty-six, or sixty frames per second, such that a convolution performed on the data may be performed with substantial throughput. Moreover, the processing latency may be limited to accord to a target response time, in some embodiments. For example, where the system is implemented for autonomous driving or other computer-vision applications (e.g., robotic control), the convolution may be used to extract meaningful features from the input data structure. The features may, in turn, be used to provide control signals for navigational operations of the autonomous vehicle, or other motion planning or motion control application.

According to a convolutional operation (e.g., the deplaning of operation 204), further data structures e.g., a first plane 222 and a second plane 224 can be generated. The first plane 222 can include one portion (e.g., an MSB) of the data elements of the input data structure 220 and the second plane 224 can include another portion (e.g., an LSB) of the data elements of the input data structure 220. For example, where a sixteen-bit data element 226 (e.g., red pixel value) of the input data structure 220 is provided as 0x3A7F, the first plane 222 can include 0x3A in a corresponding first data element 228 and the second plane 224 can include 0x3A in a corresponding second data element 230. The respective planes can be generated according to a convolution of predefined kernel corresponding to the convolution of operation 204.

The computing device can obtain a weight 232 of a machine learning model for convolution with the input data structure 220. The weight 232 can correspond to a bit-width of the input data structure. However, where the first plane 222 and second plane 224 contain a lesser bit-width than the input data structure 220, a first portion of the weight 232 can be provided (as a multiplicand) to a multiplier, along with another multiplicand, such as the data element of the first plane 222 or the second plane 224. In some embodiments, the bit width of the weight 232, or a portion thereof associated with a particular plane can vary from the bit-width of elements of the associated plane. For example, a bit-width of a portion of a weight associated with the first plane 222 or the second plane 224 can be larger or smaller than the first data element 228 or the second data element 230. More particularly, zero padding (e.g., for unsigned data elements) or sign extension (e.g., for signed data elements) can be applied to the one of the data elements or the weights 232 having the lesser bit-width.

The multiplier 234 can be implemented as a multiplier of a MAC 236. In some embodiments, a same MAC 236 can generate the product for the first and second portion of the weight 232 (e.g., serially). In some embodiments, different instances of the MAC 236 can generate the products for the first and second portion of the weight 232 (e.g., according to a simultaneous or other parallel operation). In some embodiments, the summation may be performed by a third MAC 236, or one of the different instances of the MAC 236. For example, the multiplier can multiply a first product by 256 to left-shift the product and thereafter sum the left-shifted product with an adder 238 of the MAC 236 (e.g., MSB) with the other product (e.g., LSB). The output may be stored in an accumulator 240 of the MAC 236, another register, or another memory location. Such computations can be repeated to execute the various models of a machine-learning model (e.g., convolving weights across the input data structure 220). In further examples of the present disclosure, the convolution operation can be substituted for further operations. For example, the weights can be used for projection (e.g., Q, K, or V projections or dimension reducing or expanding), normalization (e.g., BatchNorm, LayerNorm), or attention mechanisms (e.g., self-attention or masked/causal attention), among other operations.

Continuing the previous example, the MSB of the weight 232, 0xDE can be multiplied with the MSB of the input data structure 220, 0x3A to realize a first output 242 having a value of 0x324C. The LSB of the weight 232, 0xAD can be multiplied with the LSB of the input data structure 220, 0x7F, to realize a second output 244 having a value of 0x55D3. The LSB value may thereafter be summed with the MSB (each multiplied by 256 to left-shift the MSB to a MSB position) to realize an output word 246 having a value of 0x324C55D3. The convolution can thereafter be carried across the respective data strictures, to include the LSB weight multiplied with the MSB value ((0xAD)(0x3A)=0x273200) and the MSB weight multiplied with the LSB value ((0xDE)(0x7F)=0x6E2200). Thus, a total can sum to a correct product of 0x32E1A9D3. In some embodiments, some such operations may be omitted to generate lower precision data to operate in a lower precision mode. Even so, according to some data values, the output word 246 can overflow (e.g., may not be stored in sixteen-bits), accordingly, the output format can be configured to store such values. Further, the eight-bit MAC may not be configured to multiply by 256 (e.g., the eight bits representing a maximum value of 255, according to some formats). An example format can include the format referred to above with respect to, for example, operations 212 and 214. A graphical depiction of the format is provided hereinafter.

FIG. 2C depicts examples of data formats of binary-data words 242-246 as implemented by a compute device that performs the operations of the method 200, according to some embodiments. The data format can be used to represent various data values, such as products of image data and weights consisting of natural numbers (e.g., represented in a binary-integer format). However, use of a format associated with floating point values (e.g., two's compliment with an exponent and a mantissa rather than a standard binary representation) can store the thirty-two-bit output in a sixteen-bit register or other memory location, so as to pack two words into one storage location. The format can be used for any of a first output 242, second output 244, or output word 246, or a subset thereof.

The format includes a sign bit 250 in some embodiments. For example, the sign bit 250 may be processed efficiently for a pipeline configured to receive floating point numbers to aid throughput. In some embodiment, the sign bit may be omitted or repurposed (e.g., be used as a flag or to extend an exponent 252 or mantissa 254). The format includes an exponent 252 to represent the scale or magnitude of a number (e.g., in scientific notation, indicating how many places the decimal point should be shifted). The format includes a mantissa 254 (sometimes referred to as a significand) to encode the significant digits of a number, providing the precise value within the scale defined by the exponent 252. Accordingly, allocating additional bits to the exponent 252 at the expense of the mantissa 254 can aid in increasing a maximum value and dynamic range of a stored value. Conversely, allocating additional bits to the mantissa 254 at the expense of the exponent 252 can aid in increasing a precision of a value with the dynamic range (e.g., reduce discretization error). To store the thirty-two-bit value of the output word 246 depicted above, in FIG. 2B, a relatively large exponent 252 can be selected with a relatively small mantissa 254. For example, the exponent 252 can be represented by more bits than the mantissa (e.g., a five-bit mantissa and a ten-bit exponent 252 can store the output word 246). In some embodiments, the first output 242 and the second output 244 can use a same format, as may reduce complexity. In some embodiments, the first output 242 and the second output 244 can use a different format (e.g., a six-bit mantissa and a nine-bit exponent 252), to increase pre-summation precision. Such an implementation may be useful, for example, where the intermediate outputs are used for another purpose in addition to the generation of the output word 246.

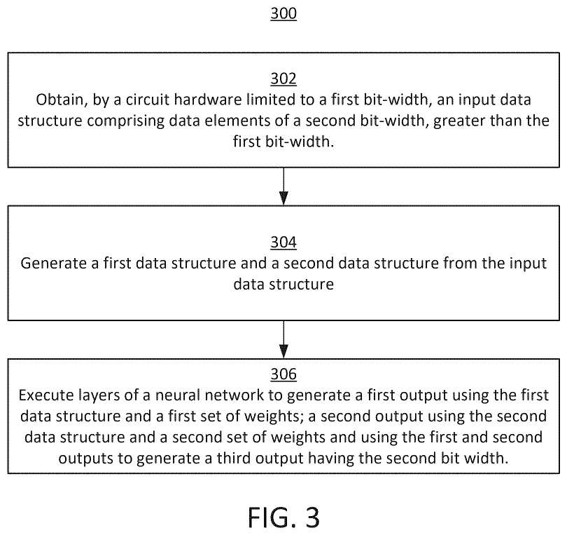

FIG. 3 depicts an example method 300 for performing arithmetic on processing hardware, according to some embodiments. The method 300 can be performed by a circuit (e.g., one or more circuits of the compute device) for a first bit-width that may include various multiplier-accumulators, each configured to obtain an input word having a first bit-width (e.g., eight-bits), obtain weights, of a set of weights having the first bit-width, and generate a multiplicand having the second bit-width.

At operation 302, the circuit obtains an input data structure including various elements of a second bit-width, greater than the first bit-width. For example, the input data structure can include pixel data of an input image or spatial data for a machine vision system. In some embodiments, the input data structure consists of natural numbers (e.g., pixel values of intensity or for colors, such as red, green, and blue for each pixel).

At operation 304, the circuit generates a first and second data structure from the input data structure, each of the first data structure and the second data structure having a bit-width that does not exceed the first bit-width. To generate the first data structure and the second data structure, the circuit can convolve, using an array of multiplier-accumulators (MACs) of the first bit-width, predefined kernels with the input data structure. For example, the predefined kernels can include or consist of single-entry matrices, the convolution with the plurality of predefined kernels having a stride length equal to a number of columns.

At operation 306, the circuit executes one or more layers of a neural network of a machine-learning architecture to generate a first output, the one or more layers of the neural network taking as inputs the first data structure and a set of one or more weights. In some embodiments, the circuit can execute the one or more layers of the convolutional neural network of the machine-learning architecture to generate a second output. To generate the second output, the one or more layers of the convolutional neural network can take, as inputs, the second data structure and a second set of one or more weights. The set of one or more weights and the second set of one or more weights can each be of a bit-width not exceeding the first bit-width. The circuit can obtain the set of one or more weights and the second set of one or more weights as a single weight element of the second bit-width. The circuit can generate, using the first output and the second output, a third output having the second bit-width.

The output can be formatted to pack multiple data elements into a space for a single data element. For example, the format can include an exponent and a mantissa, the exponent having a greater number of bits than the mantissa. The format can include a number of bits equal to the second bit-width. In some embodiments, the format may be used to store or transfer each of the first output, the second output, and the third output.

The depicted operations are not intended to be limiting. For example, and according to the various aspects of the present disclosure, operations can be omitted, added, substituted, or modified. For example, in some embodiments, the method 300 can include generating control signals to execute a navigational action based on one or more outputs (e.g., the third output). Such a navigational action can be by an autonomous vehicle, robot, or other device coupled with a compute device configured to execute the method 300.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, attributes, or memory contents. Information, arguments, attributes, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module that may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method for performing arithmetic on processing hardware, the method comprising:
obtaining, by a circuit hardware-limited to a first bit-width, an input data structure comprising a plurality of elements of a second bit-width, greater than the first bit-width;
generating, by the circuit, a first data structure and a second data structure from the input data structure, the first data structure and the second data structure having a bit-width that does not exceed the first bit-width;
executing, by the circuit, one or more layers of a neural network of a machine-learning architecture to generate a first output, the one or more layers of the neural network taking as inputs the first data structure and a first set of one or more weights;
executing, by the circuit, the one or more layers of the neural network of the machine-learning architecture to generate a second output, the one or more layers of the convolutional neural network taking as inputs the second data structure and a second set of one or more weights; and
generating, by the circuit using the first output and the second output, a third output having the second bit-width.

2. The method of claim 1, wherein generating the first data structure and the second data structure comprises convolving, by the circuit using an array of multiplier-accumulators (MACs) of the first bit-width, a plurality of predefined kernels with the input data structure.

3. The method of claim 2, wherein the plurality of predefined kernels comprise single-entry matrices, wherein the circuit convolves the plurality of predefined kernels having a stride length equal to a number of columns of the plurality of kernels.

4. The method of claim 1, wherein the neural network includes a convolutional neural network,
wherein the first set of one or more weights and the second set of one or more weights are:
of a bit-width not exceeding the first bit-width, and
obtained, by the circuit as a single weight element of the second bit-width.

5. The method of claim 1, further comprising generating, by the circuit, the first output according to a format having a mantissa and an exponent having a greater number of bits than the mantissa.

6. The method of claim 4, further comprising generating, by the circuit, the first output, the second output, and the third output according to a format having:
the second bit-width,
a mantissa, and
an exponent, the exponent having a greater number of bits than the mantissa.

7. The method of claim 6, wherein the input data structure consists of natural numbers.

8. The method of claim 7, wherein the input data structure comprises pixel data of an input image.

9. The method of claim 7, wherein the input data structure comprises image data for a machine vision system configured to navigate a three-dimensional environment based on the image data.

10. The method of claim 9, further comprising generating control signals to execute a navigational action to cause an ego vehicle to navigate the environment based on the third output.

11. The method of claim 1, wherein the circuit comprises multiplier-accumulators configured to:
obtain an input word having the first bit-width;
obtain weights, of the first set of one or more weights, having the first bit-width; and
generate a multiplicand having the second bit-width.

12. A system for arithmetic computation, the system comprising:
a circuit hardware-limited to a first bit-width and configured to:
obtain an input data structure comprising a plurality of elements of a second bit-width, greater than the first bit-width;
generate a first data structure and a second data structure from the input data structure, the first data structure and the second data structure having a bit-width that does not exceed the first bit-width;
execute one or more layers of a neural network of a machine-learning architecture to generate a first output, the one or more layers of the neural network taking as inputs the first data structure and a first set of one or more weights;
execute the one or more layers of the neural network of the machine-learning architecture to generate a second output, the one or more layers of the convolutional neural network taking as inputs the second data structure and a second set of one or more weights; and
generate, using the first output and the second output, a third output having the second bit-width.

13. The system of claim 12, wherein, to generate the first data structure and the second data structure, the circuit is configured to:
convolve, using an array of multiplier-accumulators (MACs) of the first bit-width, a plurality of predefined kernels with the input data structure.

14. The system of claim 13, wherein the plurality of predefined kernels comprise single-entry matrices, and wherein the circuit convolves the plurality of predefined kernels having a stride length equal to a number of columns of the plurality of kernels.

15. The system of claim 12, wherein the neural network includes a convolutional neural network, and wherein the first set of one or more weights and the second set of one or more weights are:
of a bit-width not exceeding the first bit-width, and
obtained as a single weight element of the second bit-width.

16. The system of claim 12, wherein the circuit is configured to generate the first output according to a format having an exponent and a mantissa, the exponent having a greater number of bits than the mantissa.

17. The system of claim 15, wherein the circuit is configured to generate the first output, the second output, and the third output according to a format having:
the second bit-width,
a mantissa, and
an exponent, the exponent having a greater number of bits than the mantissa.

18. The system of claim 17, wherein the input data structure consists of natural numbers.

19. The system of claim 12, wherein the circuit comprises multiplier-accumulators configured to:
obtain an input word having the first bit-width;
obtain weights, of the first set of one or more weights, having the first bit-width; and
generate a multiplicand having the second bit-width.

20. An autonomous vehicle comprising:
one or more sensors configured to generate an input data structure having a plurality of data elements which exceed a first bit-width and are equal to a second bit-width, and consisting of natural numbers; and
a circuit hardware-limited to data of the first bit-width, configured to:
obtain the input data structure comprising the plurality of data elements of the second bit-width;
generate, via a convolution using an array of multiplier-accumulators (MACs) of the first bit-width, a plurality of predefined kernels with the input data structure, a first data structure and a second data structure from the input data structure, the first data structure and the second data structure having a bit-width that does not exceed the first bit-width;
execute one or more layers of a neural network of a machine-learning architecture to generate a first output of the second bit-width, the one or more layers of the neural network taking as inputs the first data structure having the first bit-width and a first set of one or more weights having the first bit-width; and
execute the one or more layers of the convolutional neural network of the machine-learning architecture to generate a second output of the second bit-width, the one or more layers of the convolutional neural network taking as inputs the second data structure having the first bit-width and a second set of one or more weights having the first bit-width.
